(19) United States
(12) Patent Application Publication
(10) Pub. No.: US 2024/0127351 A1
(43) Pub. Date: Apr. 18, 2024

(54) INFORMATION PROCESSING APPARATUS, INFORMATION PROCESSING SYSTEM, AND INFORMATION PROCESSING METHOD

(71) Applicant: TOYOTA JIDOSHA KABUSHIKI KAISHA, Toyota-shi Aichi-ken (JP)

(72) Inventors: Yosuke NITTA, Kashiwa-shi Chiba-ken (JP); Yu HAMADA, Nagoya-shi Aichi-ken (JP)

(73) Assignee: TOYOTA JIDOSHA KABUSHIKI KAISHA, Toyota-shi Aichi-ken (JP)

(21) Appl. No.: 18/379,692

(22) Filed: Oct. 13, 2023

(30) Foreign Application Priority Data
Oct. 18, 2022 (JP) 2022-166900

(51) Int. Cl. G06Q 40/08

(52) U.S. Cl. CPC G06Q 40/08

(57) ABSTRACT

An information processing apparatus comprises a processor, the processor being configured to execute: acquiring first data indicating that a first vehicle component has been added to a first vehicle later; and registering, if a contract of first vehicle insurance that covers the first vehicle exists, and the first data is acquired, with a database managing content of the contract of the first vehicle insurance, that the first vehicle component is covered by the first vehicle insurance.

### CROSS REFERENCE TO THE RELATED APPLICATION

This application claims the benefit of Japanese Patent Application No. 2022-166900, filed on Oct. 18, 2022, which is hereby incorporated by reference herein in its entirety.

### BACKGROUND

### Technical Field

The present disclosure relates to automobile insurance.

### Description of the Related Art

There is known a system that centrally manages information about automobile insurance.

As an disclosure related thereto, for example, a system that calculates an insurance premium according to a driver's driving characteristics is disclosed in Japanese Patent Laid-Open No. 2009-128486.

### SUMMARY

An object of the present disclosure is to appropriately update content of an insurance contract for an automobile.

The present disclosure in its one aspect provides an information processing apparatus comprising a processor, the processor being configured to execute: acquiring first data indicating that a first vehicle component has been added to a first vehicle later; and registering, if a contract of first vehicle insurance that covers the first vehicle exists, and the first data is acquired, with a database managing content of the contract of the first vehicle insurance, that the first vehicle component is covered by the first vehicle insurance.

The present disclosure in its another aspect provides an information processing system comprising: a first apparatus configured to manage content of a contract of the first vehicle insurance corresponding to a first vehicle; and a second apparatus corresponding to a base where fitting of a vehicle component to the first vehicle is at least performed; wherein if a first vehicle component is added to the first vehicle later, the second apparatus transmits first data that identifies the first vehicle component to the first apparatus; and if the contract of first vehicle insurance that covers the first vehicle exists, and the first apparatus receives the first data, the first apparatus registers, with a database managing content of the contract of the first vehicle insurance, that the first vehicle component is covered by the first vehicle insurance.

The present disclosure in its another aspect provides an information processing method comprising the steps of: acquiring first data indicating that a first vehicle component has been added to a first vehicle later; and registering, if a contract of first vehicle insurance that covers the first vehicle exists, and the first data is acquired, with a database managing content of the contract of the first vehicle insurance, that the first vehicle component is covered by the first vehicle insurance.

Another aspect of the present disclosure is a program for causing a computer to execute the above information processing method or a computer-readable storage medium that non-transitorily stores the program.

According to the present disclosure, it is possible to appropriately update content of an insurance contract for an automobile.

### BRIEF DESCRIPTION OF THE DRAWINGS

FIG. 1 is a diagram illustrating an overview of an insurance system in a first embodiment;

FIG. 2 is a diagram illustrating an overview of automobile insurance;

FIG. 3 is a diagram illustrating configurations of a management server and a base server;

FIG. 4 illustrates an example of contract data stored in the management server;

FIG. 5 illustrates an example of component data stored in the management server;

FIG. 6 illustrates an example of work data transmitted from the base server;

FIG. 7 is a flowchart of a process executed by the base server;

FIG. 8 illustrates an example of a screen for the base server to acquire information about work;

FIG. 9 is a flowchart of a process executed by the management server;

FIG. 10 illustrates an example of contract data in a second embodiment;

FIG. 11 is a diagram illustrating an overview of an insurance system in a third embodiment;

FIG. 12 is a flowchart of a process executed by the management server in the third embodiment; and

FIG. 13 illustrates an example of data for identifying an insurance company with which a contract is concluded for a predetermined vehicle.

### DESCRIPTION OF THE EMBODIMENTS

Recently, an environment where it is possible to easily upgrade a vehicle component of an automobile has been prepared. For example, it is possible to, by exchanging an onboard computer (an onboard terminal or an electronic controller), easily add a function to a vehicle. Further, it is possible to add a function not only by exchanging hardware but also by updating software.

By upgrading a vehicle later as above, the value of the vehicle can be improved.

On the other hand, as for automobile insurance, later improvement of a value of a vehicle is not considered in many cases. For example, an upper limit of an insurance benefit paid by vehicle insurance generally decreases as years pass after registration of a new vehicle. This is because a value of the vehicle is calculated according to an amount equivalent to a market price.

Therefore, when a vehicle component is upgraded later, a discrepancy may be caused between an actual value of the vehicle and a vehicle insurance benefit set when automobile insurance was contracted. Further, it may happen that the vehicle component added later is not covered by vehicle insurance. In such a case, it may happen that when an accident occurs, all occurred damages cannot be compensated for.

An information processing apparatus according to the present disclosure solves such a problem.

An information processing apparatus according to a first aspect of the present disclosure includes a controller configured to execute: acquiring first data indicating that a first vehicle component has been added to a first vehicle later; and registering, if a contract of first vehicle insurance that covers the first vehicle exists, and the first data is acquired, with a database managing content of the contract of the first vehicle insurance, that the first vehicle component is covered by the first vehicle insurance.

The information processing apparatus is an apparatus capable of accessing a database of contracts of automobile insurance (vehicle insurance). The vehicle insurance is insurance that compensates for damages caused on a vehicle. The database may store vehicle insurance coverage for each of a plurality of vehicles. The first data may be received from an external apparatus or the like or may be inputted by a user of the apparatus. The external apparatus can be, for example, an apparatus corresponding to a maintenance facility or the like where addition of a vehicle component is performed.

The information processing apparatus judges that the first vehicle component has been added to a first vehicle later (that is, at a timing after the timing of the first vehicle being manufactured) from the first acquired data.

The first vehicle component does not necessarily have to be a hardware component. For example, the first vehicle component may be software executed on an onboard computer. In this case, the first vehicle component may be new software or software of a version newer than the version of software that has been installed. That is, “the first vehicle component having been added later” may be “new software having been installed” or “upgraded software having been installed”.

If the contract of the automobile insurance (vehicle insurance) that covers the first vehicle exists, and the first vehicle component is added to the first vehicle later, the controller registers with the database that the first vehicle component is covered by the insurance.

This process may be, for example, a process for updating an upper limit of an insurance benefit according to an appraisal value of the first vehicle component or may be a process for clearly indicating that the first vehicle component is included in insurance coverage.

According to such a configuration, even if the first vehicle is upgraded later, it becomes possible to cover an improved part of the value of the first vehicle by the vehicle insurance.

If receiving second data indicating that a second vehicle component has been removed from the first vehicle, the controller may register with the database that the second vehicle component is not covered by the insurance any more.

Further, for the contract of the vehicle insurance to which the first vehicle component is added as being covered by the insurance, the controller may recalculate the insurance premium. The insurance premium may be increased based on the improved part of the value of the first vehicle.

Whether it is favorable or not to add the first vehicle component to the insurance coverage depends on an owner of the vehicle.

For example, if the first vehicle is a loaned vehicle such as a leased vehicle, it is favorable that all including the added component are covered by the insurance. On the other hand, if the first vehicle is owned by a user, whether or not to cause the added vehicle component to be covered by the insurance depends on determination by the user.

Therefore, the controller may further acquire third data indicating whether the first vehicle is a leased vehicle or not and perform a different process based on the third data.

For example, the registration may be performed if the first vehicle is a leased vehicle and may not be performed if the first vehicle is not a leased vehicle.

If the first vehicle is a leased vehicle, a lease fee of the first vehicle may be recalculated based on the recalculated insurance premium.

Further, if the first vehicle is a leased vehicle, an insurance coverage period of the first vehicle component may be set, with a lease term of the first vehicle as a maximum period.

Specific embodiments of the present disclosure will be described below based on drawings. A hardware configuration, a module configuration, a function configuration, and the like described in each embodiment are not intended to limit the technical scope of the disclosure only thereto unless otherwise described.

### First Embodiment

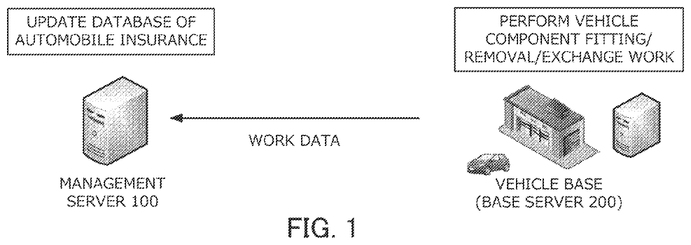

An overview of an insurance system according to a first embodiment will be described with reference to FIG. 1.

The insurance system according to the present embodiment is configured, including an apparatus that manages automobile insurance contracts for a plurality of vehicles (a management server 100) and an apparatus corresponding to a vehicle base where fitting of a vehicle component and the like are performed (a base server 200).

The management server 100 is an apparatus that manages data of the automobile insurance contracts. The management server 100 may be an apparatus under management of an insurance company.

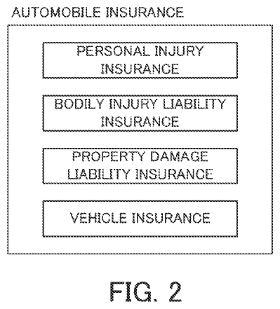

As illustrated in FIG. 2, automobile insurance includes a plurality of types of insurance such as personal injury insurance, bodily injury liability insurance, property damage liability insurance, and vehicle insurance. In the present embodiment, it is assumed that an automobile insurance contract includes a vehicle insurance contract.

The management server 100 holds information about, for a predetermined vehicle, what content a concluded predetermined insurance contract has (for example, what is the content of compensation for a concluded vehicle insurance contract).

The base server 200 is a server apparatus associated with a base where fitting, removal, or exchange work of a vehicle component is performed (hereinafter, a vehicle base). In the present example, though hardware components are assumed as vehicle components, the vehicle components may be software components. In this case, the vehicle base may be a base where addition, deletion or update of software that operates on an onboard computer is performed. In this case, the fitting, removal, and exchange work can be replaced with software installation work, uninstallation work, and update work, respectively.

The vehicle base is, for example, a vehicle manufacturing factory, a maintenance facility, a car dealer, or the like. When work is performed for a predetermined vehicle, the base server 200 generates data representing details of the work (hereinafter, work data) and transmits the work data to the management server 100.

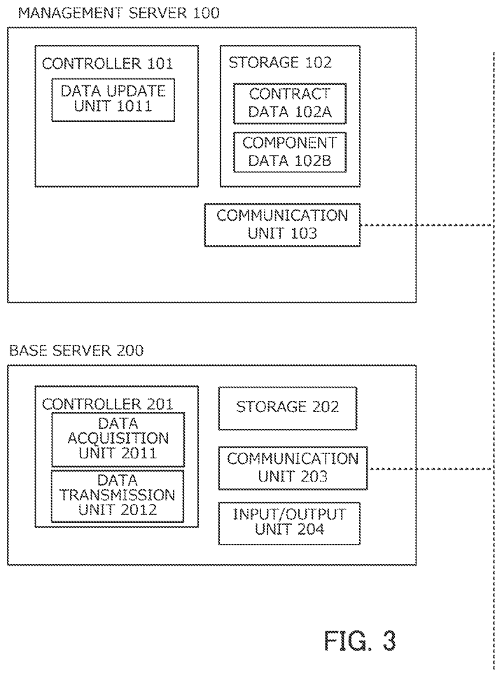

FIG. 3 is a diagram illustrating components of the management server 100 and the base server 200 that are included in the insurance system according to the present embodiment in more detail.

First, the management server 100 will be described.

The management server 100 stores a database that manages, for a plurality of vehicles under its management, content of automobile insurance contracts. Further, the management server 100 updates the database based on work data received from the base server 200.

The management server 100 can be configured as a computer that includes a processor such as a CPU or a GPU, a main memory such as a RAM and a ROM, auxiliary storage devices such as an EPROM, a hard disk drive, and a removable medium. In an auxiliary storage device, an operating system (OS), various kinds of programs, various kinds of tables and the like are stored. By loading a program stored therein to a work area of the main memory, executing the program, and each of components and the like being controlled through the execution of the program, each of functions that meet predetermined purposes as described later can be realized. A part or all of the functions may be realized by a hardware circuit like an ASIC and an FPGA.

In the present embodiment, the management server 100 may be configured to be capable of executing a Web server for performing interaction with the base server 200. In this case, for example, by the base server 200 accessing Web services using a browser, input/output of information can be performed. The management server 100 may provide services by techniques other than the Web server. For example, a service of performing interaction with dedicated application software installed in the base server 200 using a predetermined protocol may be executed in the management server 100.

The management server 100 is configured, including a controller 101, a storage 102, and a communication unit 103.

The controller 101 is an arithmetic device in charge of control performed by the management server 100. The controller 101 can be realized by an arithmetic processing device such as a central processing unit (CPU).

The controller 101 is configured, including a data update unit 1011 as a function module. The function module may be realized by executing a stored program by the CPU.

The data update unit 1011 updates content of a vehicle insurance contract in an automobile insurance contract, based on work data received from the base server 200.

Specifically, the data update unit 1011 executes any of the following processes.

(1) Process for, when a New Vehicle Component is Fitted to an Insured Vehicle, Adding the Vehicle Component as being Covered by Insurance

When a new vehicle component is fitted to an insured vehicle, the data update unit 1011 performs the process for adding the newly fitted vehicle component as being covered by vehicle insurance.

If, when a certain vehicle component is newly fitted to a vehicle, the vehicle component is fastened or fixed to the vehicle, the vehicle component is regarded as a part of the vehicle and is covered by insurance. Therefore, in such a case, the data update unit 1011 records data clearly indicating that the newly fitted vehicle component is a part of the vehicle related to a contract (that is, the vehicle component is covered by vehicle insurance) to the database.

(2) Process for, when an Existing Vehicle Component is Removed, Exclude the Vehicle Component from Insurance Coverage

On the other hand, when a vehicle component is removed, the vehicle component is not regarded as a part of a vehicle. Therefore, in such a case, the data update unit 1011 records data clearly indicating that the removed vehicle component is not a part of the vehicle related to a contract any more (that is, the vehicle component is not covered by vehicle insurance any more) to the database.

(3) Process for, when a Vehicle Component is Exchanged, Updating Insurance Coverage

When a vehicle component is exchanged, the vehicle component before the exchange is not covered by insurance any more, and a vehicle component after the exchange is newly covered by the insurance. Therefore, in such a case, the data update unit 1011 records data clearly indicating that a vehicle component constituting a vehicle has been changed (that is, insurance coverage has changed) to the database.

The storage 102 is configured, including a main memory and an auxiliary storage device. The main memory is a memory where a program executed by the controller 101 and data used by the control program are developed. The auxiliary storage device is a device in which the program executed by the controller 101 and the data used by the control program are stored.

Further, the storage 102 stores contract data 102A and component data 102B.

The contract data 102A is data about insurance contracts of managed vehicles.

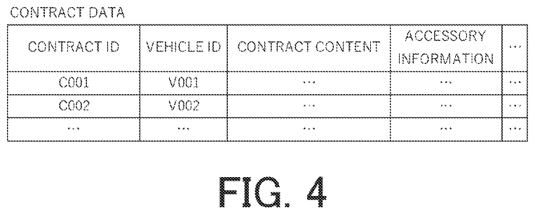

FIG. 4 illustrates an example of the contract data 102A. As illustrated, the contract data 102A is configured, including contract ID, vehicle ID, contract content, and each field of accessory information.

The contract ID fields are fields in which identifiers that uniquely identify automobile insurance contracts are stored.

The vehicle ID fields are fields in which identifiers that uniquely identify vehicles are stored.

The contract content field are fields in which data about content of concluded automobile insurance contracts is stored. As such data, for example, data about the presence/absence, amount, and range of personal injury insurance, the presence/absence and amount of bodily injury liability insurance, the presence/absence and amount of property damage liability insurance, the presence/absence and amount of vehicle insurance, and the like can be exemplified.

In the accessory information fields, identifiers that identify vehicle components attached to insured vehicles are stored. For example, when a certain vehicle component is fitted later, an identifier of the vehicle component is stored in a corresponding accessory information field. When a certain vehicle component is registered as an accessory, the vehicle component is covered by vehicle insurance as an element constituting a vehicle. When the insured vehicle component is software, either an identifier of the software or an identifier of hardware that executes the software may be stored in the accessory information field.

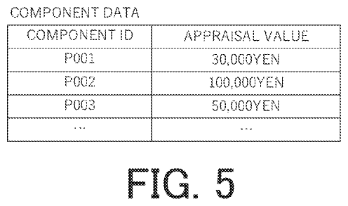

The component data 102B is data about vehicle components that can be added to an insured vehicle. FIG. 5 illustrates an example of the component data 102B. As illustrated, the component data 102B is configured, including each field of component ID and appraisal value.

The component ID fields are fields in which identifiers that uniquely identify vehicle components are stored.

The appraisal value fields are fields in which appraisal values (insurance benefits) of corresponding vehicle components are stored.

Each kind of data described above may be constructed by a program of a database management system (DBMS) executed by the processor that manages data to be stored in the storage device. In this case, each kind of data can be, for example, a relational database.

The communication unit 103 is a communication interface for connecting the management server 100 to a network. The communication unit 103 is configured including, for example, a network interface board and a wireless communication interface for wireless communication.

Next, the base server 200 will be described.

The base server 200 is an apparatus installed at a base where fitting work and removal work of a vehicle component are performed. When the work is performed for a vehicle, the base server 200 transmits data about content of the work to the management server 100. The work is performed, for example, when being ordered by a user.

Similarly to the management server 100, the base server 200 can be configured as a computer that includes a processor such as a CPU or a GPU, a main memory such as a RAM and a ROM, auxiliary storage devices such as an EPROM, a hard disk drive, and a removable medium.

The base server 200 is configured, including a controller 201, a storage 202, a communication unit 203, and an input/output unit 204.

The controller 201 is an arithmetic device in charge of control performed by the base server 200. The controller 201 can be realized by an arithmetic processing device such as a CPU.

The controller 201 is configured, including two function modules of a data acquisition unit 2011 and a data transmission unit 2012. Each function module may be realized by executing a stored program by the CPU.

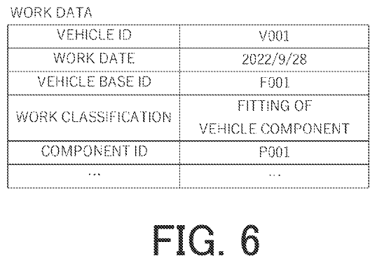

The data acquisition unit 2011 generates work data based on content of an input made by a person in charge at the vehicle base. FIG. 6 is a diagram exemplifying content of the work data.

As illustrated, the work data includes each field of vehicle ID, work date, vehicle base ID, work classification, and component ID.

In the vehicle ID field, an identifier (for example, a body number, a VIN (vehicle identification number), or the like) that uniquely identifies a vehicle for which work was performed is stored. In the work date filed, a date when the work was performed is stored. In the vehicle base ID field, an identifier that uniquely identifies a vehicle base where the work was performed is stored. In the work classification field, any of “fitting (of vehicle component)”, “removal (of vehicle component)”, and “exchange (of vehicle component)” is stored.

In the component ID field, an identifier of a vehicle component for which the work was performed is stored.

The data transmission unit 2012 transmits work data generated by the data acquisition unit 2011 to the management server 100.

The storage 202 is configured, including a main memory and an auxiliary storage device. The main memory is a memory where a program executed by the controller 201 and data used by the control program are developed. The auxiliary storage device is a device in which the program executed by the controller 201 and the data (including work data) used by the control program are stored.

The communication unit 203 is a communication interface for connecting the base server 200 to a network. The communication unit 203 is configured including, for example, a network interface board and a wireless communication interface for wireless communication.

The input/output unit 204 is a unit that accepts an input operation performed by the user (the person in charge) of the base server 200 and presents information to the user. The input/output unit 204 may include, for example, an interface with an external display, a keyboard, a mouse, and the like.

The configuration illustrated in FIG. 3 is a mere example, and all or a part of the illustrated functions may be executed with dedicatedly designed circuits. Further, storage and execution of the program may be performed by a combination of a main memory and an auxiliary storage device other than the illustrated combination.

Next, details of a process executed by each apparatus included in the insurance system will be described.

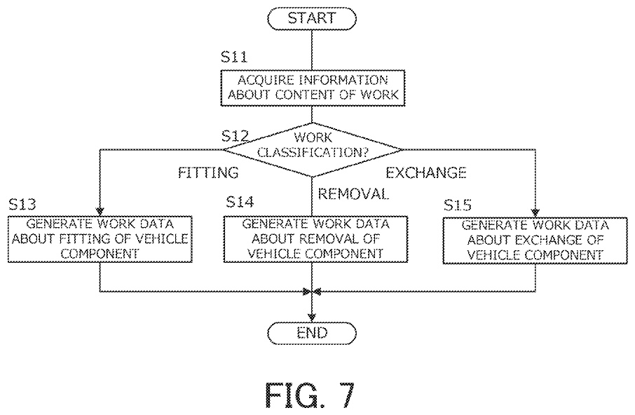

FIG. 7 is a flowchart illustrating a process executed by the base server 200 (the data acquisition unit 2011). The process illustrated in FIG. 7 is executed when work for a vehicle is performed at a predetermined vehicle base.

First, at step S11, information about content of work is acquired. At this step, for example, an identifier of a vehicle and a work classification are acquired. In the present example, the work classification is any of “fitting (of vehicle component)”, “removal (of vehicle component)”, and “exchange (of vehicle component)”. Here, fitting of a vehicle component means to newly fit the vehicle component.

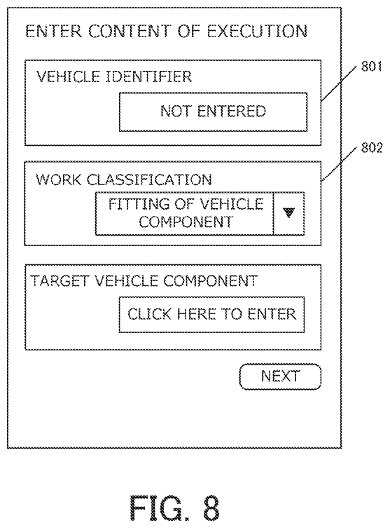

The above pieces of information may be inputted, for example, via a screen as illustrated in FIG. 8. In the example of FIG. 8, reference sign 801 represents a GUI part for causing an identifier of a vehicle to be inputted. Reference sign 802 represents a GUI part for causing a work classification to be selected.

At step S12, it is judged whether the work classification is any of “fitting”, “removal”, and “exchange”.

If the work classification is “fitting”, the process transitions to step S13, where work data to the effect that a vehicle component has been newly fitted is generated. The work data includes an identifier of the newly fitted vehicle component.

If the work classification is “removal”, the process transitions to step S14, where work data to the effect that a vehicle component has been removed is generated. The work data includes an identifier of the removed vehicle component.

If the work classification is “exchange”, the process transitions to step S15, where work data to the effect that a vehicle component has been exchanged is generated. The work data includes identifiers of the removed vehicle component and a newly fitted vehicle component.

If a vehicle component is software, the identifier may be a combination of an identifier and version of software.

The notification data generated by the base server 200 is transmitted to the management server 100 and processed by the data update unit 1011.

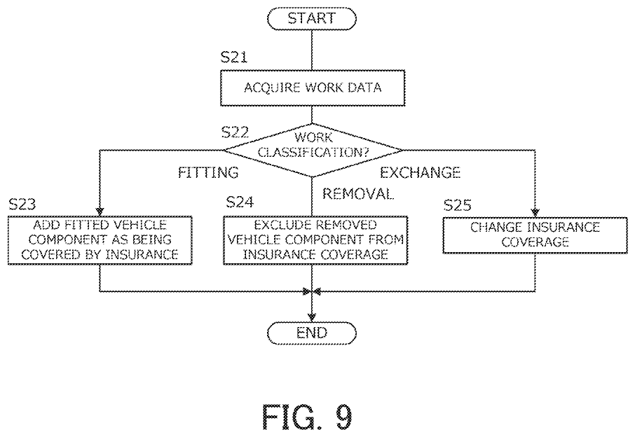

FIG. 9 is a flowchart of a database update process performed by the management server 100 (the data update unit 1011).

First, at step S21, notification data transmitted from the base server 200 is acquired.

Next, at step S22, it is judged whether the work classification is any of “fitting”, “removal”, and “exchange”.

If the work classification is “fitting”, the process transitions to step S23, where a newly fitted vehicle component is added as being covered by insurance. Specifically, an identifier of the newly fitted vehicle component is stored in accessory information about a corresponding record of the contract data 102A.

If the work classification is “removal”, the process transitions to step S24, where a removed vehicle component is excluded from insurance coverage. Specifically, an identifier of the removed vehicle component is deleted from an accessory information field of a corresponding record of the contract data 102A.

If the work classification is “exchange”, the process transitions to step S25, where a removed vehicle component is deleted from insurance coverage, and a newly fitted vehicle component is added as being covered by the insurance. Specifically, after an identifier of the removed vehicle component is deleted from an accessory information field of a corresponding record of the contract data 102A, and an identifier of the newly fitted vehicle component is added.

As described above, in the insurance system according to the first embodiment, the management server 100 performs the process for registering a vehicle component as a part of a vehicle, based on work performed for the vehicle. Thereby, it is possible to cause all vehicle components currently fitted to a vehicle to be covered by vehicle insurance.

In the first embodiment, the management server 100 performs the process for changing vehicle insurance coverage based on content of work performed for a predetermined vehicle. When vehicle insurance coverage changes, however, an insurance premium may change. Therefore, the management server 100 may execute a process for recalculating an insurance premium of vehicle insurance, based on updated content of the database. The process may be executed, for example, at a timing when the process illustrated in FIG. 9 is completed. An increased/decreased amount of an insurance premium may be decided, for example, based on an appraisal value of the vehicle component concerned, which is recorded in the component data 102B. Further, the management server 100 may execute a process for reflecting the recalculated insurance premium on the contract.

### Second Embodiment

In the first embodiment, a vehicle component to be covered by vehicle insurance is registered with the database as illustrated in FIG. 4. However, there may be a vehicle insurance contract in which those covered by the insurance are not registered one by one but are managed based on an upper limit amount.

A second embodiment is an embodiment in which, when a vehicle component is fitted to or removed from a predetermined vehicle, an amount set as an upper limit of vehicle insurance is changed.

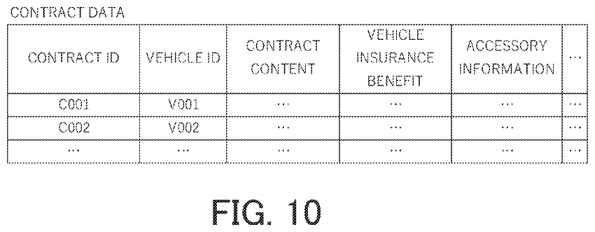

In the second embodiment, a vehicle insurance contract is managed based on an upper limit amount. FIG. 10 illustrates an example of the contract data 102A in the second embodiment. Vehicle insurance benefit fields are fields in which upper limit amounts of insurance benefits paid under corresponding contracts are stored. The upper limit amount of an insurance benefit is generally an appraisal value of the whole vehicle (including fitted vehicle components).

Further, in the second embodiment, when receiving work data, the data update unit 1011 recalculates an appraisal value of a whole vehicle that fluctuates accompanying fitting or removal of a vehicle component, and updates a vehicle insurance benefit with the determined amount.

The appraisal value of a whole vehicle that fluctuates accompanying fitting or removal of a vehicle component can be decided, for example, based on an appraisal value of the vehicle component recorded in the component data 102B.

For example, at step S23, the data update unit 1011 performs a process for adding an appraisal value of a newly added vehicle component to a vehicle insurance benefit. Further, at step S24, the data update unit 1011 performs a process for subtracting an appraisal value of a removed vehicle component from the vehicle insurance benefit. Further, at step S25, the data update unit 1011 performs a process for subtracting an appraisal value of a removed vehicle component from the vehicle insurance benefit and adding an appraisal value of an added vehicle component to the vehicle insurance benefit.

Thus, it is possible to define vehicle insurance coverage by an amount of money.

### Third Embodiment

In the first and second embodiments, if a configuration of vehicle components mounted on a vehicle is changed, vehicle insurance coverage is unconditionally changed.

This, however, may not be favorable, depending on an owner of a vehicle. For example, if a vehicle is loaned to a user from a company (for example, a leasing company), it is favorable that all the vehicle components are covered by insurance. On the other hand, if an owner of a vehicle is a user himself, whether or not to cause any vehicle component to be covered by insurance depends on the user's determination.

In order to cope with the above point, a third embodiment is an embodiment in which, based on an owner of a vehicle, it is decided whether vehicle components of the vehicle are to be covered by insurance or not.

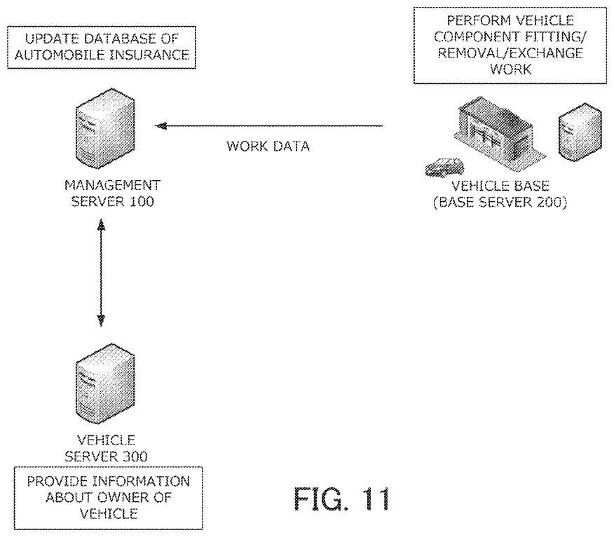

FIG. 11 is a schematic diagram of an insurance system in the third embodiment. As illustrated, the insurance system in the third embodiment is configured, further including a vehicle server 300.

The vehicle server 300 is an apparatus that manages owner information about a plurality of vehicles under the management of the system. In the present embodiment, the vehicle server 300 searches for information about an owner of a vehicle, with an identifier (for example, a VIN (vehicle identification number) and the like) of the vehicle as a key.

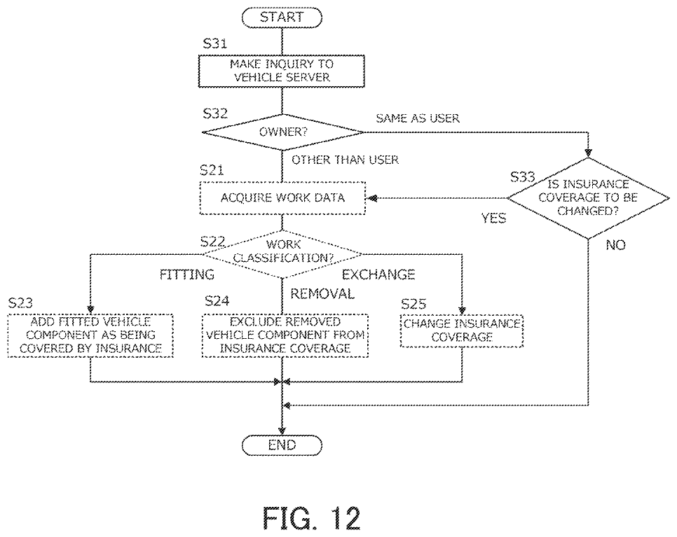

FIG. 12 is a flowchart of a process executed by the management server 100 (the data update unit 1011) in the third embodiment.

First, at step S31, an inquiry is made to the vehicle server 300 to acquire information about an owner of an insured vehicle. The inquiry can be made using an identifier that uniquely identifies the insured vehicle. The information about the owner of the insured vehicle can be, for example, any of “the owner and the user are the same person” and “the owner and the user are not the same person”.

If it can be judged whether the insured vehicle is a loaned vehicle or not, the vehicle server 300 may provide other data.

At step S32, it is judged whether the owner and the user are the same person or not. Here, if the owner and the user are the same person, the process transitions to step S33, where the user is caused to select whether or not to perform a process for changing insurance coverage accompanying increase/decrease in the vehicle components. If a positive judgment is made here, the process proceeds to step S21, where the process described before is executed. The same goes for the case where the owner and the user are not the same person at step S32. In other cases, the process ends.

According to the third embodiment, it becomes possible to, when an owner of a vehicle is different from a user (that is, a vehicle is a loaned vehicle), cause the process for changing insurance coverage to be automatically executed.

In the third embodiment, the management server 100 may also execute the process for recalculating an insurance premium of vehicle insurance, based on updated content of the database.

Furthermore, when the insured vehicle is a leased vehicle, a usage fee (for example, a monthly usage fee) of the leased vehicle may be changed, accompanying change in an insurance premium. Therefore, the management server 100 may execute a process for recalculating the usage fee of the leased vehicle based on the recalculated insurance premium.

Further, in the third embodiment, an insurance period of a corresponding vehicle component may be caused to correspond to a lease term of the insured vehicle or set to a period the maximum deadline of which is the expiration of the lease.

(Modification)

The above embodiments are mere examples, and the present disclosure can be appropriately changed and implemented within a range not departing from its spirit.

For example, the processes and structure described in the present disclosure can be freely combined and implemented as far as technical contradiction does not occur.

Further, though the management server 100 stored the database about automobile insurance contracts in each embodiment, the database does not necessarily have to be stored in the management server 100.

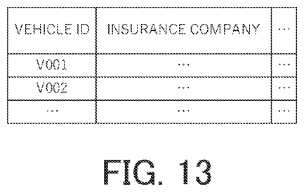

For example, if there are a plurality of companies that underwrite automobile insurance contracted by users of vehicles, a plurality of server apparatuses may store databases. In this case, the management server 100 that has received work data may identify a database apparatus of a corresponding insurance company and transmit an instruction to update the database from the management server 100 to the database apparatus. Therefore, as illustrated in FIG. 13, the management server 100 may store data in which identifiers of vehicles and information identifying insurance companies providing automobile insurance (identifiers of the insurance companies, identifiers, IP addresses, or the like of database apparatuses corresponding to the insurance companies) are associated.

Processing described as being performed by one apparatus may be shared and executed by a plurality of apparatuses. Or alternatively, processing described as being performed by different apparatuses may be executed by one apparatus. In a computer system, what hardware configuration (server configuration) each function is realized by can be flexibly changed.

The present disclosure can be realized by supplying a computer program implemented with the functions described in the above embodiments to a computer, and one or more processors that the computer has reading out and executing the program. Such a computer program may be provided for the computer by a non-transitory computer-readable storage medium connectable to a system bus of the computer or may be provided for the computer via a network. As the non-transitory computer-readable storage medium, for example, a disk of a given type such as a magnetic disk (a floppy (R) disk, a hard disk drive (HDD) and the like) and an optical disc (a CD-ROM, a DVD disc, a Blu-ray disc and the like), a read-only memory (ROM), a random-access memory (RAM), an EPROM, an EEPROM, a magnetic card, a flash memory, an optical card, and a medium of a given type that is appropriate for storing electronic commands are included.

What is claimed is:

1. An information processing apparatus comprising a processor, the processor being configured to execute:
acquiring first data indicating that a first vehicle component has been added to a first vehicle later; and
registering, if a contract of first vehicle insurance that covers the first vehicle exists, and the first data is acquired, with a database managing content of the contract of the first vehicle insurance, that the first vehicle component is covered by the first vehicle insurance.

2. The information processing apparatus according to claim 1, further comprising the database configured to store vehicle insurance coverage for each of a plurality of vehicles.

3. The information processing apparatus according to claim 1, wherein
the processor further acquires second data indicating that a second vehicle component has been removed from the first vehicle; and
if the contract of the first vehicle insurance that covers the first vehicle exists, and the second data is acquired, the processor registers with the database that the second vehicle component is not covered by the first vehicle insurance any more.

4. The information processing apparatus according to claim 1, wherein the processor recalculates an insurance premium of the first vehicle insurance based on content of the database after the registration.

5. The information processing apparatus according to claim 4, wherein the processor further acquires third data indicating whether the first vehicle is a leased vehicle or not.

6. The information processing apparatus according to claim 5, wherein, if the first vehicle is a leased vehicle, the processor recalculates a lease fee of the first vehicle based on the recalculated insurance premium.

7. The information processing apparatus according to claim 5, wherein the processor performs the registration if the first vehicle is a leased vehicle and does not perform the registration if the first vehicle is not a leased vehicle.

8. The information processing apparatus according to claim 7, wherein, if the first vehicle is a leased vehicle, the processor sets an insurance coverage period of the first vehicle component, with a lease term of the first vehicle as a maximum period.

9. An information processing system comprising:
a first apparatus configured to manage content of a contract of the first vehicle insurance corresponding to a first vehicle; and
a second apparatus corresponding to a base where fitting of a vehicle component to the first vehicle is at least performed; wherein
if a first vehicle component is added to the first vehicle later, the second apparatus transmits first data that identifies the first vehicle component to the first apparatus; and
if the contract of first vehicle insurance that covers the first vehicle exists, and the first apparatus receives the first data, the first apparatus registers, with a database managing content of the contract of the first vehicle insurance, that the first vehicle component is covered by the first vehicle insurance.

10. The information processing system according to claim 9, wherein
the second apparatus further transmits second data indicating that a second vehicle component has been removed from the first vehicle, to the first apparatus; and
if the contract of the first vehicle insurance that covers the first vehicle exists, and the first apparatus receives the second data, the first apparatus registers with the database that the second vehicle component is not covered by the first vehicle insurance any more.

11. The information processing system according to claim 9, wherein the first apparatus recalculates an insurance premium of the first vehicle insurance based on content of the database after the registration.

12. The information processing system according to claim 11, wherein the first apparatus further receives third data indicating whether the first vehicle is a leased vehicle or not.

13. The information processing system according to claim 12, wherein, if the first vehicle is a leased vehicle, the first apparatus recalculates a lease fee of the first vehicle based on the recalculated insurance premium.

14. The information processing system according to claim 12, wherein the first apparatus performs the registration if the first vehicle is a leased vehicle and does not perform the registration if the first vehicle is not a leased vehicle.

15. The information processing system according to claim 14, wherein, if the first vehicle is a leased vehicle, the first apparatus sets an insurance coverage period of the first vehicle component, with a lease term of the first vehicle as a maximum period.

16. An information processing method comprising the steps of:
acquiring first data indicating that a first vehicle component has been added to a first vehicle later; and
registering, if a contract of first vehicle insurance that covers the first vehicle exists, and the first data is acquired, with a database managing content of the contract of the first vehicle insurance, that the first vehicle component is covered by the first vehicle insurance.

17. The information processing method according to claim 16, further comprising a step of acquiring second data indicating that a second vehicle component has been removed from the first vehicle; wherein
if the contract of the first vehicle insurance that covers the first vehicle exists, and the second data is acquired, it is registered with the database that the second vehicle component is not covered by the first vehicle insurance any more.

18. The information processing method according to claim 16, further comprising a step of recalculating an insurance premium of the first vehicle insurance based on content of the database after the registration.

19. The information processing method according to claim 18, further comprising a step of acquiring third data indicating whether the first vehicle is a leased vehicle or not.

20. The information processing method according to claim 19, wherein, if the first vehicle is a leased vehicle, a lease fee of the first vehicle is recalculated based on the recalculated insurance premium.
